(19) United States
(12) Patent Application Publication
(10) Pub. No.: US 2007/0043663 A1
(43) Pub. Date: Feb. 22, 2007

(54) E-payment advice system

(76) Inventor: Mark Simpson, Redwood City, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/357,857

(22) Filed: Feb. 17, 2006

Related U.S. Application Data
(60) Provisional application No. 60/709,409, filed on Aug. 16, 2005.

(51) Int. Cl. G06Q 40/00

(52) U.S. Cl. 705/39

(57) ABSTRACT

An e-payment advice system includes a at least one payor computer system generating payment instructions and payment advice records. At least one web-based server receives and stores payment advice records from the payor and generates a unique identifier for each payment advice records and returns the identifier to the payor after receipt of the payment advice record. At least one payor banking computer system matches the identifier with the payment instructions and transmits the matched data to the payor banking computer system. At least one payee banking computer system transmits the identifier and a payment in accordance with the payment instructions to the payee banking computer system which transmits the unique identifier to the payee. The payee transmits the identifier to the web-based server which transmits the payment advice record identified by the identifier to the payee which will then close out the accounts receivable related to the payment advice.

### PRIOR APPLICATION

This application claims priority from U.S. Provisional Application Ser. No. 60/709,409 filed Aug. 16, 2005.

### FIELD OF INVENTION

The invention pertains to electronic payment systems. More particularly, the invention relates to systems for providing advice of payments made electronically while eliminating the requirement for paper check processing.

### BACKGROUND OF THE INVENTION

The vast majority of Business to Business payments in the US are made via check, simply because there is no viable method for corporations and banks to share payment advice data. Payment advices tell the payee (beneficiary) what is being paid, so that the payee's account receivable department can book cash and clear accounts receivable. Sarbanes Oxley and GAAP require that corporations maintain accurate books and do not overstate balance sheet items such as accounts receivable and cash.

The ACH and Fed Wire systems presently in use in the United States only supports 80 characters of additional information which is not sufficient for the type of detailed payment advice typically required for commercial transactions. Consequently, corporations still continue to receive payment via check and receive remittance data via lockbox files. The check processing is slow, expensive, labor intensive, and subject to fraud.

Banks have not been forthcoming with automated solutions and appear to favor legacy check processing.

Various systems have been developed in attempts to eliminate paper check processing and/or to provide automated payment advice. U.S. Patent Application No. 2005/0021464, issued to Lindauer, describes systems and methods for transmitting payment advice data from a payment computer system to a payee computer system are provided. An exemplary method may include generating a payment order and payment advice data. The method may further include generating a unique identifier for the payment order, transmitting the payment order and the unique identifier to a banking computer system, and transmitting the payment advice data and the unique identifier to a central computer system. The method may further include sending bank statement data indicative of an execution of the payment order to the payee computer system, where the bank statement data includes the unique identifier of the payment order. The method may further include storing the payment advice data and the unique identifier in the central computer system, in response to a receipt of the bank statement data by the payee computer system, and requesting the payment advice data from the central computer system using the unique identifier as a key.

U.S. Patent Application No. 2005/0049947, issued to Mueller et al. discloses methods and systems are provided for processing one or more bills from a biller by a customer. Methods and systems may receive a request to pay one or more of a set of one or more bills in total or in part on a site of a computer network. A selection of the one or more bills to a biller may be sent, said selection responding to said request via said site. Methods and systems may receive an electronic advice of settlement of the selected bills and/or an ID of said advice of settlement from the biller and send a payment order comprising the ID of said advice of settlement to a payment service provider.

U.S. patent application No. 2004/0034594, issued to Thomas describes a method for effecting electronic payment, safeguarding banking and account information, while utilizing existing payment systems. The method comprises generating a system routing number and a payment identification code (PIC) relating to the beneficiary's account information, distributing payment identification codes to the existing payment system and financial institutions owning the account related to the payment identification codes, and the originator receiving a system routing number and the beneficiary's PIC number. The method also includes the originator communicating a payment instruction to a financial institution of the originator, wherein the payment instruction includes the system routing number beneficiary's payment identification code, the originator's financial institution receiving the payment instruction from the originator, wherein if the received PIC matches the originator's financial institution internal list of PICs, the originator's financial institution performs an “on us” transaction, and transmitting a payment instruction to an existing payment system in a case where the received PIC does not match originator's financial institution internal list of PICs. The method also includes the existing payment system validating the received PIC, wherein if the PIC is invalid, the payment instruction is returned to the originator's financial institution, converting the PIC and system routing number to a receiving payment instruction in a case where the PIC is a valid PIC, wherein the receiving payment instruction includes the beneficiary's financial institution's routing number and the beneficiary's account number. The existing payment system transmits the receiving payment instruction to a financial institution of the beneficiary, that financial institution credits the beneficiary's account if no problem exists, and otherwise returns a receiving payment instruction to the existing payment system. Upon receipt of the returned receiving payment instruction, the existing payment system translates the receiving payment instruction into the payment instruction prior to transmitting the payment instruction back to originator's financial institution.

U.S. Pat. No. 6,029,150, issued to Kravitz, discloses a method of payment in an electronic payment system wherein a plurality of customers have accounts with an agent. A customer obtains an authenticated quote from a specific merchant, the quote including a specification of goods and a payment amount for those goods. The customer sends to the agent a single communication including a request for payment of the payment amount to the specific merchant and a unique identification of the customer. The agent issues to the customer an authenticated payment advice based only on the single communication and secret shared between the customer and the agent and status information which the agent knows about the merchant and/or the customer. The customer forwards a portion of the payment advice to the specific merchant. The specific merchant provides the goods to the customer in response to receiving the portion of the payment advice.

U.S. Patent Application No. 2004/0111368, issued to Cuthbertson et al. describes a system and method for permitting purchases over a communication medium such as the Internet is provided. A payment identifier is produced when a purchaser makes a purchase from a merchant. This payment identifier is generated by a payment establishment. The payment identifier is communicated to the purchaser. The purchaser then takes the payment identifier to a payment establishment to make an in-person payment. The payment identifier does not have to display in human readable form the identify of the merchant or the goods or services purchased. When in-person payment is made at the payment establishment, the merchant is advised, and the purchased goods or services can then be delivered by the merchant. The system and method takes away the uncertainty associated with making payment on-line by providing credit card or like details over the communication medium. The payment establishment can be a respected organization with whom purchases can feel comfortable with in so far as disclosing their credit card or like details. Typically the payment establishment can be a Post Office.

It is an objective of the present invention to provide a system that will permit payors to make electronic payments to satisfy outstanding accounts payable, thereby eliminating paper check processing. It is a further objective to provide a web based service that enables payees and payors to exchange payment advice data without affect existing bank and payment clearing systems such as ACH and Fed Wire. It is a still further objective of the invention to supplement payment orders with payment advice data by running in parallel to banking systems. Finally, it is an objective of the present invention to offer corporations many open system alternatives for sending and receiving advice data, thereby ensuring that corporations will not be dependant on banks clearing systems.

While some of the objectives of the present invention are disclosed in the prior art, none of the inventions found include all of the requirements identified.

### SUMMARY OF THE INVENTION

The present invention addresses all of the deficiencies of prior art e-payment advice system inventions and satisfies all of the objectives described above.

(1) An e-payment advice system providing the desired features may be constructed from the following components. At least one payor computer system is provided. The payor computer system generates payment instructions and payment advice records. At least one web-based server is provided. The server receives and stores payment advice records from the payor and generates a unique identifier for each of the payment advice records. The server returns the unique identifier to the payor after receipt of the payment advice record. At least one payor banking computer system is provided. The payor computer system matches the unique identifier with the payment instructions and transmits the matched data to the payor banking computer system. At least one payee banking computer system is provided. The payor banking system transmits the unique identifier and a payment in accordance with the payment instructions to the payee banking computer system. The payee banking computer system transmits the unique identifier to the payee. The payee transmits the unique identifier to the web-based server. The web-based server transmits the payment advice record identified by the unique identifier to the payee. When the payee receives the payment advice it will close out accounts receivable related to the payment advice.

(2) In a variant of the invention, the web-based server receives and maintains payor and payee account information. The account information, and bank statement data, provide a mechanism to identify payment advice information generated by a payor to a payee without use of the unique identifier.

(3) In another variant, the bank statement data comprises payment date, payment amount, payor name, payor account number, payor bank routing number, payee bank routing number and payee bank account number.

(4) In still another variant, the payor and payee account information includes payor and payee names, payor and payee institutional identifying number, payor and payee Web Service Account Number. Each of the names and the numbers provides an alternative means for matching payment advice information to an appropriate payor and an appropriate payee.

(5) In yet another variant, the payee banking computer system transmits a bank statement showing receipt of funds along with the unique identifier to the payee after receipt of the payment from the payor banking system. The bank statement confirms that accounts receivable related to the payment advice should be closed out.

(6) In a further variant, the system includes a registration certificate. The certificate provides a mechanism for a payor to invite a payee to create an account on the web-based server and enter the payor's account information.

(7) In still a further variant, the payor routes the unique identifier to the payor banking system records of not more than 80 characters.

(8) In yet a further variant, the payor banking computer system routes the unique identifier to the payee banking system using either a locally or internationally accepted payment clearing system.

(9) In another variant of the invention, the payor and payee account information include notification systems preferred by the payor and the payee.

(10) In still another variant, the system automatically notifies the payee of a payment advice received via notification system designated on the payee's account information.

(11) In yet another variant, the system includes a plurality of software utilities, the software utilities provide means for posting and retrieving the payment advice information to and from the server.

(12) In a further variant, includes alternative means for retrieving the payment advice information. The alternative means includes online queries, file downloads and automated scheduled queries.

(13) In still a further variant, the software utilities interface with accounting systems to automatically retrieve the payment advice information from the server.

(14) In yet a further variant, the software utilities interface with accounting systems such as Enterprise Resource Planning (ERP) systems to automatically post the payment advice information to the web-based server and to automatically retrieve the unique identifier generated by the system associated with the payment advice information.

(15) In another variant of the invention, the payor manually posts the payment advice information to the server using manual file uploading procedures.

(16) In still another variant, the payor routes the payment instructions to the web-based server. The system routes the payment instructions to either of the payor bank and bank clearing systems.

(17) In yet another variant, the bank statement data is used to correct posting of the payment advice records incorrectly posted to another payee.

(18) In a final variant, the system is implemented in parallel to existing bank clearing systems, thereby minimizing impact to the bank clearing systems.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a schematic view of the preferred embodiment of the invention illustrating the web based server, payor and payee accounting and banking systems and the flow of payment advice information, payments and the unique identifier;

FIG. 2 is a sample bank statement;

FIG. 3 is a schematic view of a Web Server database;

FIG. 4 is a schematic view of Web Server processes; and

### DETAILED DESCRIPTION OF THE PREFERRED EMBODIMENT

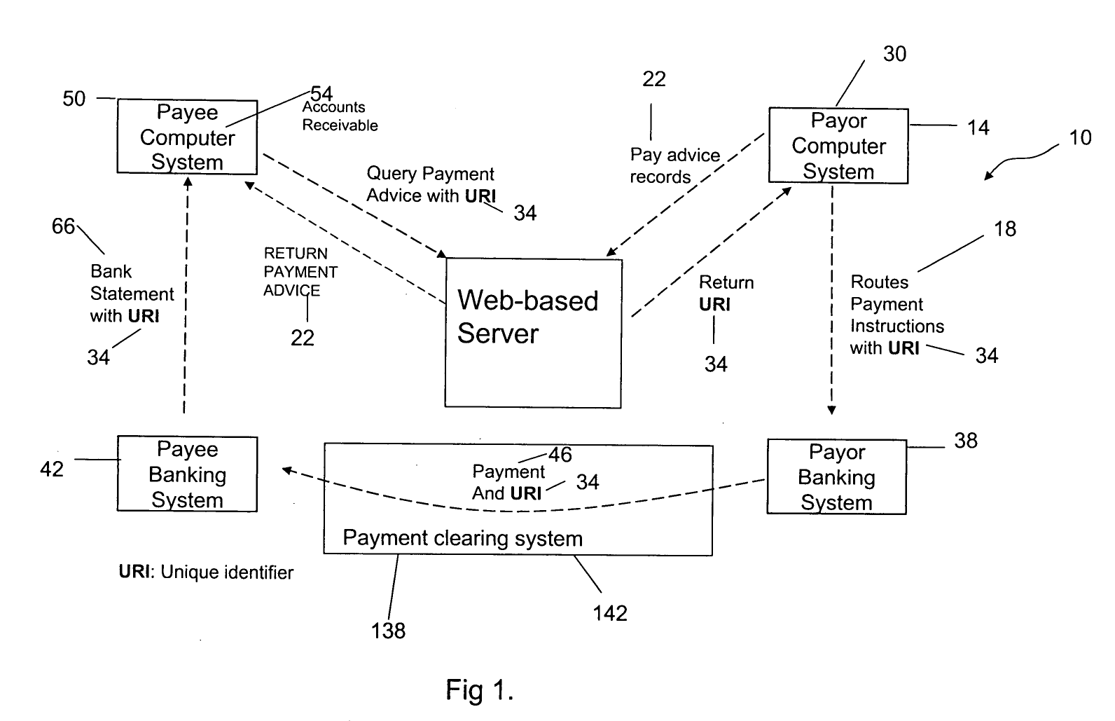

(1) FIGS. 1-4 illustrate an e-payment advice system 10 providing the desired features may be constructed from the following components. As illustrated in FIG. 1, at least one payor computer system 14 is provided. The payor computer system 14 generates payment instructions 18 and payment advice records 22. At least one web-based server 26 is provided. The server 26 receives and stores payment advice records 22 from the payor 30 and generates a unique identifier 34 for each of the payment advice records 22. The server 26 returns the unique identifier 34 to the payor 30 after receipt of the payment advice record 22.

At least one payor banking computer system 38 is provided. The payor computer system 14 matches the unique identifier 34 with the payment instructions 18 and transmits the matched data to the payor banking computer system 38. At least one payee banking computer system 42 is provided. The payor banking system 38 transmits the unique identifier 34 and a payment 46 in accordance with the payment instructions 18 to the payee banking computer system 42. The payee banking computer system 42 transmits the unique identifier 34 to the payee 50. The payee 50 transmits the unique identifier 34 to the web-based server 26. The web-based server 26 transmits the payment advice record 22 identified by the unique identifier 34 to the payee 50. When the payee 50 receives the payment advice 22 it will close out accounts receivable 54 related to the payment advice 22.

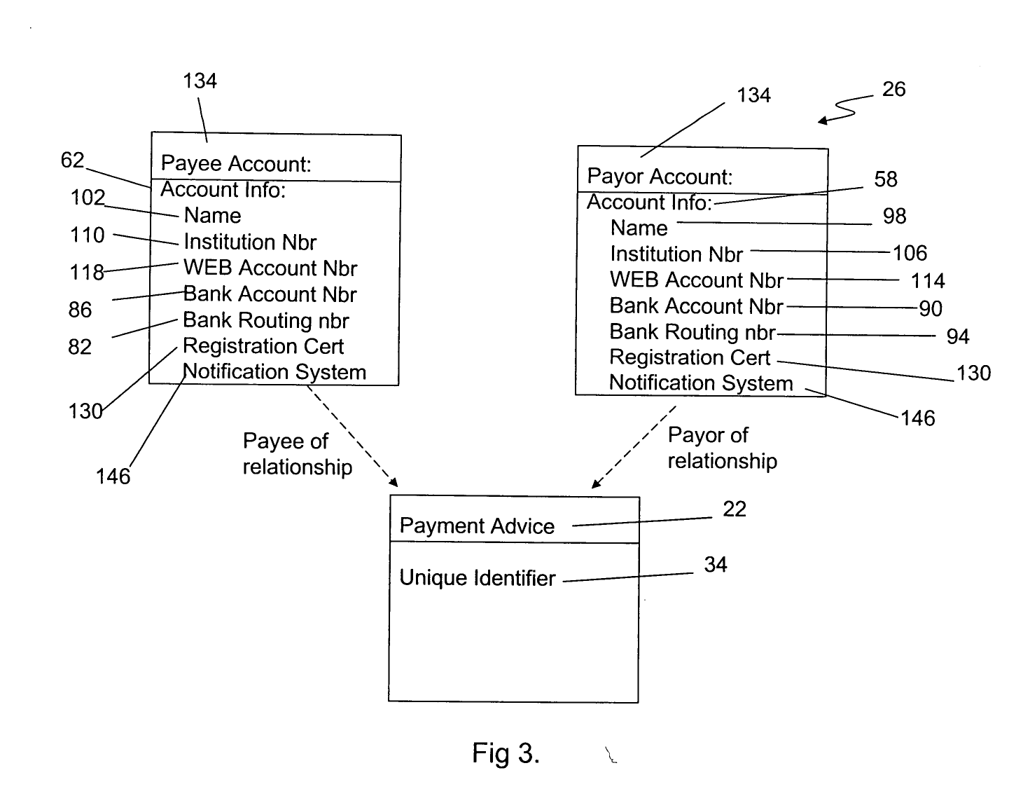

(2) In a variant of the invention, as illustrated in FIG. 3, the web-based server 26 receives and maintains payor 58 and payee 62 account information. The account information 58, 62, and bank statement data 66, provide a mechanism to identify payment advice information 22 generated by a payor 30 to a payee 50 without use of the unique identifier 34.

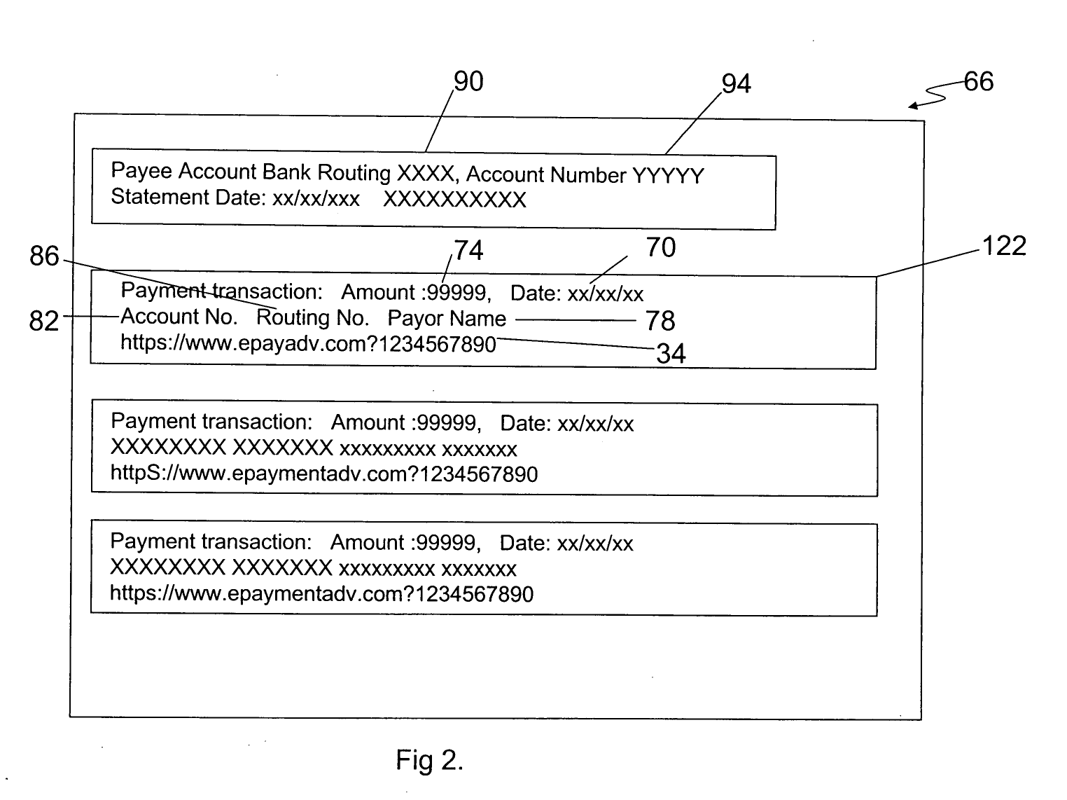

(3) In another variant, as illustrated in FIG. 2, the bank statement data 66 comprises payment date 70, payment amount 74, payor name 78, payor account number 82, payor bank routing number 86, payee bank routing number 90 and payee bank account number 94.

(4) In still another variant, as illustrated in FIG. 3, the payor 58 and payee 62 account information includes payor 98 and payee 102 names, payor 106 and payee 110 institutional identifying number, payor 114 and payee 118 Web Service Account Number. Each of the names 98, 102 and the numbers 114, 118 provides an alternative means for matching payment advice information 22 to an appropriate payor 30 and an appropriate payee 50.

(5) In yet another variant, as illustrated in FIG. 2, the payee banking computer system 42 transmits a bank statement 66 showing receipt of funds 122 along with the unique identifier 34 to the payee 50 after receipt of the payment 46 from the payor banking system 42. The bank statement 66 confirms that accounts receivable 54 related to the payment advice 22 should be closed out.

(6) In a further variant, as illustrated in FIG. 3, the system 10 includes a registration certificate 130. The certificate 130 provides a mechanism for a payor 30 to invite a payee 50 to create an account 134 on the web-based server 26 and enter the payor's account information 58.

(7) In still a further variant, the payor 30 routes the unique identifier 34 to the payee banking system 42 records of not more than 80 characters.

(8) In yet a further variant, as illustrated in FIG. 1, the payor banking computer system 38 routes the unique identifier 34 to the payee banking system 42 using either a locally 138 or internationally 142 accepted payment clearing system.

(9) In another variant of the invention, as illustrated in FIG. 3, the payor 58 and payee 62 account information include notification systems 146 preferred by the payor 30 and the payee 50.

(10) In still another variant, the system 10 automatically notifies the payee 50 of a payment advice 22 received via notification system 146 designated on the payee's account information 62.

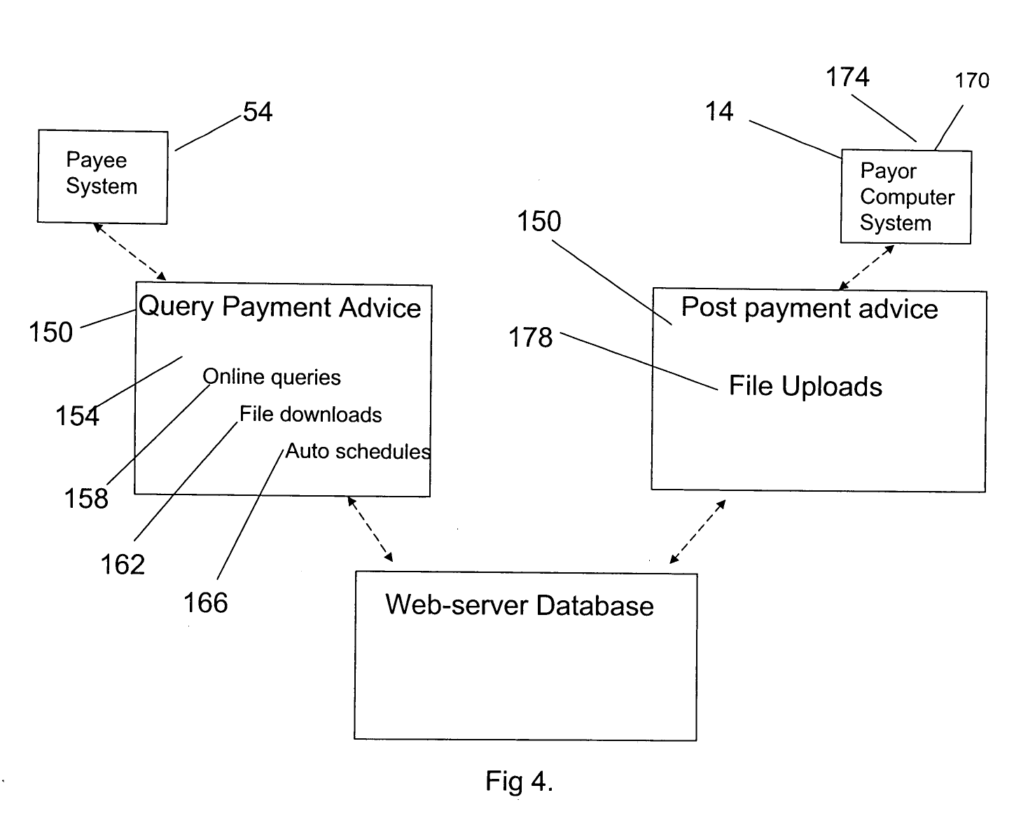

(11) In yet another variant, as illustrated in FIG. 4, the system 10 includes a plurality of software utilities 150, the software utilities 150 provide means for posting and retrieving the payment advice information 22 to and from the server 26.

(12) In a further variant, includes alternative means 154 for retrieving the payment advice information 22. The alternative means 154 includes online queries 158, file downloads 162 and automated scheduled queries 166.

(13) In still a further variant, the software utilities 150 interface with accounting systems 170 to automatically retrieve the payment advice information 22 from the server 26.

(14) In yet a further variant, the software utilities 150 interface with accounting systems 170 such as Enterprise Resource Planning (ERP) systems 174 to automatically post the payment advice information 22 to the web-based server 26 and to automatically retrieve the unique identifier 34 generated by the system 10 associated with the payment advice information 22.

(15) In another variant of the invention, the payor 30 manually posts the payment advice information 22 to the server 26 using manual file uploading procedures 178.

(16) In still another variant, as illustrated in FIG. 1, the payor 30 routes the payment instructions 18 to the web-based server 26. The system 10 routes the payment instructions 18 to either of the payor bank 38 and bank clearing systems 138, 142.

(17) In yet another variant, the bank statement data 66 is used to correct posting of the payment advice records 22 incorrectly posted to another payee 50.

(18) In a final variant, the system 10 is implemented in parallel to existing bank clearing systems 138, 142, thereby minimizing impact to the bank clearing systems 138, 142.

The e-payment advice system 10 has been described with reference to particular embodiments. Other modifications and enhancements can be made without departing from the spirit and scope of the claims that follow.

1. An e-payment advice system, comprising:
at least one payor computer system, said payor computer system generating payment instructions and payment advice records;
at least one web-based server, said server receiving and storing payment advice records from said payor and generating a unique identifier for each of said payment advice records;
said server returning said unique identifier to said payor after receipt of said payment advice record;
at least one payor banking computer system;
said payor computer system matching said unique identifier with said payment instructions and transmitting said matched data to said payor banking computer system;
at least one payee banking computer system;
said payor banking system transmitting said unique identifier and a payment in accordance with said payment instructions to said payee banking computer system;
said payee banking computer system transmitting said unique identifier to said payee;
said payee transmitting said unique identifier to said web-based server;
said web-based server transmitting said payment advice record identified by said unique identifier to said payee; and
whereby, when said payee receives said payment advice it will close out accounts receivable related to said payment advice.

2. The e-payment advice system, as described in claim 1, wherein said web-based server receives and maintains payor and payee account information, said account information, and bank statement data, providing a mechanism to identify payment advice information generated by a payor to a payee without use of said unique identifier.

3. The e-payment advice system, as described in claim 2, wherein said bank statement data comprises payment date, payment amount, payor name, payor account number, payor bank routing number, payee bank routing number and payee bank account number.

4. The e-payment advice system, as described in claim 2, wherein said payor and payee account information comprises:
payor and payee names;
payor and payee institutional identifying number;
payor and payee Web Service Account Number; and
each of said names and said numbers providing an alternative means for matching payment advice information to an appropriate payor and an appropriate payee.

5. The e-payment advice system, as described in claim 1, wherein said payee banking computer system transmits a bank statement showing receipt of funds along with said unique identifier to said payee after receipt of said payment from said payor banking system, said bank statement confirming that accounts receivable related to said payment advice should be closed out.

6. The e-payment advice system, as described in claim 2, further comprising a registration certificate, said certificate providing a mechanism for a payor to invite a payee to create an account on said web-based server and enter said payor's account information.

7. The e-payment advice system, as described in claim 1, wherein said payor routes said unique identifier to said payor banking system records of not more than 80 characters.

8. The e-payment advice system, as described in claim 1, wherein said payor banking computer system routes said unique identifier to said payee banking system using either of a locally and internationally accepted payment clearing system.

9. The e-payment advice system, as described in claim 2, wherein said payor and payee account information further comprise notification systems preferred by said payor and said payee.

10. The e-payment advice system, as described in claim 9, wherein said system automatically notifies said payee of a payment advice received via notification system designated on said payee's account information.

11. The e-payment advice system, as described in claim 1, further comprising a plurality of software utilities, said software utilities providing means for posting and retrieving said payment advice information to and from said server.

12. The e-payment advice system, as described in claim 11, further comprising alternative means for retrieving said payment advice information, said alternative means comprising online queries, file downloads and automated scheduled queries.

13. The e-payment advice system, as described in claim 11, wherein said software utilities interface with accounting systems to automatically retrieve said payment advice information from said server.

14. The e-payment advice system, as described in claim 11, wherein said software utilities interface with accounting systems such as Enterprise Resource Planning (ERP) systems to automatically post said payment advice information to said web-based server and to automatically retrieve said unique identifier generated by said system associated with said payment advice information.

15. The e-payment advice system, as described in claim 1, wherein said payor manually posts said payment advice information to said server using manual file uploading procedures.

16. The e-payment advice system, as described in claim 1, wherein said payor routes said payment instructions to said web-based server, said system routes said payment instructions to either of said payor bank and bank clearing systems.

17. The e-payment advice system, as described in claim 3, wherein said bank statement data is used to correct posting of said payment advice records incorrectly posted to another payee.

18. The e-payment advice system, as described in claim 1, wherein said system is implemented in parallel to existing bank clearing systems, thereby minimizing impact to said bank clearing systems.
